(19) United States
(12) Patent Application Publication
(10) Pub. No.: US 2006/0084834 A1
(43) Pub. Date: Apr. 20, 2006

(54) Recycling the chemical elements intoxic chemicals into useful and saleable chemicals

(76) Inventor: Harold Wayne Adams, Pittsburgh, PA (US)

Correspondence Address: HAROLD WAYNE ADAMS, 320 FORT DUQUESNE BULUVARD, BOX 19F, PITTSBURG, PA, 15222, US

(21) Appl. No.: 10/888,271

(22) Filed: Oct. 18, 2004

(51) Int. Cl. A62D 3/00

(52) U.S. Cl. 588/313

(57) ABSTRACT

This chemical process was conceived as a safe and economically feasible method to dispose of hazardous organic and inorganic chemicals, any and all, including chemical weapons and explosives. Other processes used such as incineration, pyrolysis, and hydrolysis and nuclear produce gaseous products which are more toxic than the original disposal feed. Example Polyvinyl Chloride Plastic shower curtain and table cloths Wall paper Floor and tile piping Incineration Dioxin, perchloro-dibenzo furans (super toxins) The incineration industry ignored the basic law of physics: “Mass cannot be destroyed, its form can only be changed.”

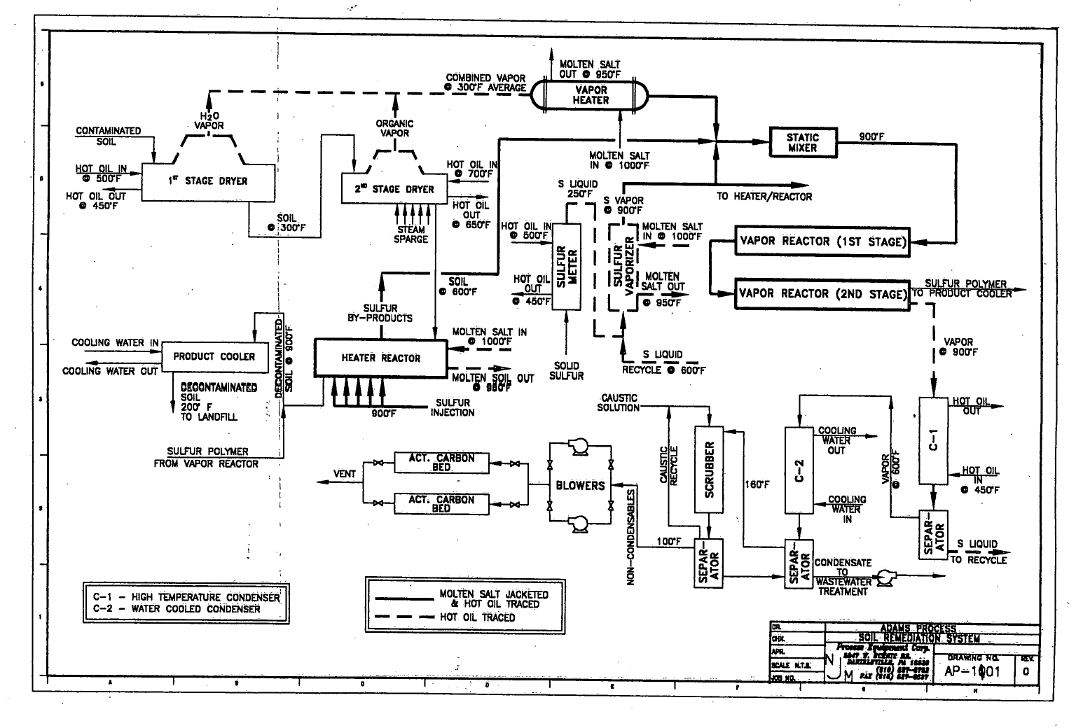

### EXECUTIVE SUMMARY

Chemical agents HD, VX and GB were exposed to sulfur vapors at 500° C. in a bench-top reactor simulating “Adams Process” conditions and found to be effectively destroyed. Reaction products identified for simulant CEES exposed to hot sulfur vapors were primarily H₂S, SO₂, CS₂ and various alkyl sulfides and for DMMP were CS₂ plus a variety of dimethyl sulfides.

### 1. INTRODUCTION

The Adams Process is a patented technology wherein organic molecules are destroyed “efficiently and safely” without high temperature incineration (Chemloop, L. P., Burns and Roe). Briefly, molten sulfur and chemical waste are simultaneously pumped into a reactor held at approximately 500° C. (boiling point for sulfur is about 444.6° C.). In the absence of oxygen, the sulfur vapors react with the organic waste molecules producing CxSy(s) polymer and simple sulfur compounds such as CS₂, H₂S, SO₂, S₂Cl₂, CSCl₂, and HCl depending on the atoms available in the waste stream. A continuous feed pilot scale production unit demonstration of the Adams Process has been performed at the Center for Hazardous Materials Research, Pittsburgh, Pa. with compounds such as trichloroethylene, trichlorobenzene, Freon 113 and Arochlor 1242. The destruction was reported to be greater than 99% efficient and the major products of reaction were those noted above. War gas compounds could not be tested for security and safety reasons. The Pine Bluff Arsenal Chemical Activity Laboratory was tasked with demonstrating in a bench-scale experiment that certain war gas compounds are destroyed by reacting with sulfur vapors and that the products of reaction are indeed relatively “safe” simple sulfur compounds.

I claim:

1. Chemical dismantling toxic chemicals (organic and/or inorganic) and conversion of the chemical elements into useful and saleable chemical compounds, without toxic emissions to the atmosphere or to water or to ground, using high temperature sulfur reactions. Reactions are performed in a suitable processor at temperatures from 350° C., to 500° C. under elemental nitrogen of 20 to 30 P.S.I.
